(19) United States
(12) Patent Application Publication
(10) Pub. No.: US 2026/0250957 A1
(43) Pub. Date: Aug. 27, 2026

(54) GUTTER CLEANING SYSTEM AND METHOD

(71) Applicant: Pangu Tech LLC, Bryn Mawr, PA (US)

(72) Inventor: Yingjie WAN, Bryn Mawr, PA (US)

(73) Assignee: Pangu Tech LLC, Bryn Mawr, PA (US)

(21) Appl. No.: 19/061,159

(22) Filed: Feb. 24, 2025

(51) Int. Cl. E04D 13/076; B08B 9/00; B08B 13/00; B64U 10/14; B64U 50/11; B64U 50/19; B64U 101/29

(52) U.S. Cl. CPC E04D 13/0765; B08B 9/00; B08B 13/00; B64U 10/14; B64U 50/11; B64U 50/19; B64U 2101/29; B64U 2201/20

(57) ABSTRACT

Disclosed herewith is a cleaning system for cleaning an above ground channel. The cleaning system includes a cleaning unit having a cleaning head coupled to a cleaning body, a flying device coupled with the cleaning unit, and a remote controller configured to control the flying device and the cleaning unit. The flying device lifts the cleaning unit above the ground and positions the cleaning unit above the channel. The cleaning head includes an air blower or a rotary head. A cleaning method includes coupling a cleaning unit to a flying device, establishing a communication link between a remote controller and the cleaning unit, controlling the flying device to position the cleaning unit in a gutter channel; and controlling the cleaning unit to implement a cleaning operation in the gutter channel. The cleaning operation includes rotating a mechanical head or blowing air in the gutter channel.

### FIELD OF THE INVENTION

The present disclosure relates generally to a gutter cleaning system and method, and, more particularly, to a cleaning system that utilizes a UAV for cleaning a gutter.

### BACKGROUND

Buildings typically have a gutter system installed around their roofs for collecting rainwater and water from thawed snow or ice. A gutter system includes a plurality of gutter channels for guiding collected water to downspouts, which direct water to the ground, dry well, or other water collecting systems. In addition to water, many other things may also fall into the gutter channels, such as dirt, leaf, tree branches, granules of the roofing shingles, and etc., which can clog the gutter channels and downspout overtime. When these things in the gutter channels are not mitigated, water could overflow the clogged gutters and cause expensive damages to abutting structures, such as walls and roofs.

Conventionally, gutters are cleaned manually by a contractor or a property owner with the assist of equipment, such as pressure washer or vacuum machines. Typically, a contractor or a property owner would climb to the roof by using a ladder and complete the cleaning project while staying on the roof. The conventional gutter cleaning methods are slow, dangerous, and time consuming. In addition, most property owners or leaseholders do not have the equipment to clean the gutters by themselves.

Thus, there is a need for an improved gutter cleaning system and method.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In an aspect, the present application discloses a cleaning system for cleaning a channel raised above a ground. The cleaning system includes a cleaning unit having a cleaning head coupled to a cleaning body, a flying device coupled with the cleaning unit, and a remote controller configured to control the flying device and the cleaning unit. The flying device is configured to lift the cleaning unit above the ground and position the cleaning unit into the channel. The cleaning head includes an air blower or a rotary head for removing dirt and other things out of the channel. The flying device may include least four rotors, and the rotors may be driven by a motor or a combustion engine.

According to various embodiments, the cleaning system includes a telescoping structure coupled with both the flying device and the cleaning unit. An electrical wire may be disposed within the telescoping structure. The cleaning system may further include a first coupling mechanism that couples the telescoping structure with the cleaning unit with an electromagnet. The cleaning system may further include a second coupling mechanism that couples the telescoping structure with the flying device.

According to various embodiments, the cleaning unit is configured to be detached from the flying device and released into the channel. The rotary head includes a blade or a brush. The cleaning unit may include a vision system, such as a camera, a battery configured to provide electricity to the rotary head and the vision system, and a plurality of wheels. The cleaning unit may include a wireless transmitter configured to communicate with the remote controller.

According to various embodiments, the cleaning system includes a gimbal structure coupled with a telescoping structure. The gimbal structure is configured to orient the telescoping structure to different directions. The cleaning system may further include a supporting frame configured to support the flying device. The supporting frame is configured to be left on the ground when the flying device lifts the cleaning unit. The telescoping structure is configured to telescope or extend by the weight of the cleaning unit.

In another aspect, the present application discloses a method for cleaning an above-ground gutter system. The method includes coupling a cleaning unit to a flying device, establishing a communication link between a remote controller and the cleaning unit, controlling the flying device to position the cleaning unit in a gutter channel; and controlling the cleaning unit to implement a cleaning operation in the gutter channel. The cleaning operation includes rotating a mechanical head or blowing air in the gutter channel.

According to various embodiments, the method further includes rotating, by a telescoping rod, the cleaning unit in different directions, releasing the cleaning unit from the telescoping rod into the gutter channel, providing, by a camera installed on the cleaning unit, an image showing conditions of the gutter channel, and retrieving the cleaning unit via the telescoping rod coupled to the flying device.

Other aspects, features, and advantages will be apparent from the below description, drawings, and claims. A variety of implementations and embodiments are described below. It is contemplated that elements and features of one implementation or embodiment may be beneficially incorporated in other implementations or embodiments without further recitation.

### BRIEF DESCRIPTION OF THE DRAWINGS

The appended drawings illustrate some embodiments or implementations of the present disclosure, briefly summarized above and described in more detailed in the following description and claims. It is to be noted, however, that the appended drawings illustrate only exemplary embodiments and are therefore not to be considered limiting of its scope, and may admit to other equally effective embodiments.

FIG. 1 illustrates a schematic configuration of a cleaning system, according to an embodiment of a present application.

FIG. 2 illustrates a perspective view of a cleaning system having four rotors, according to an embodiment of the present application.

FIG. 3 illustrates a bottom view of the cleaning system of FIG. 2, according to an embodiment of the present application.

FIG. 4 illustrates a cleaning unit inside a gutter channel, according to an embodiment of the present application.

FIG. 5 illustrates a schematic configuration of a cleaning unit, according to an embodiment of the present application.

FIG. 6 illustrates a schematic configuration of a telescoping structure, according to an embodiment of the present application.

FIG. 7 illustrates a method of cleaning a gutter system, according to an embodiment of the present application.

It is noted that like reference symbols in the appended drawings indicate like elements.

### DETAILED DESCRIPTION

Reference will now be made in detail to the various embodiments of the invention, one or more examples of which are illustrated in the figures. Within the following description of the drawings, the same reference numbers refer to same components. Generally, only the differences with respect to individual embodiments are described. Each example is provided by way of explanation of the invention and is not meant as a limitation of the invention. Further, features illustrated or described as part of one embodiment can be used on or in conjunction with other embodiments to yield yet a further embodiment. It is intended that the description includes such modifications and variations.

In the description of the present disclosure, directions or position relationships indicated by terms “center”, “longitudinal”, “landscape”, “length”, “width”, “thickness”, “upper”, “lower”, “front”, “rear”, “left”, “right”, “vertical”, “horizontal”, “top”, “bottom”, “inner”, “outer”, “clockwise”, and “counterclockwise” are merely used for describing relative positions in the drawings and should not be understood to indicate or imply that a device or an element must have a particular direction or must be constructed and operated in a particular direction. In addition, the terms “first” and “second” are used for the convenience of identification and are not to be construed as indicating or implying relative importance or a quantity of technical features indicated. Thus, features defined by “first” and “second” may explicitly or implicitly include one or more of the features.

In the description of the present disclosure, unless otherwise explicitly specified or defined, the terms such as “installation”, “couple”, and “connect” should be understood in a broad sense. For example, these terms may indicate a fixed connection, a detachable connection, or an integral connection; may be a mechanical connection, an electrical connection, or mutual communication; or may be a direct connection, an indirect connection through an intermediate, internal communication between two elements, or an interaction relationship between two elements.

The gutter cleaning system and method as described in the present application utilize an unmanned aerial vehicle (UAV) in a task for cleaning up a gutter system. One or more payloads for cleaning a gutter system can be coupled to the UAV. The payload may include a cleaning unit coupled to a telescoping structure. The UAV can deliver the payload to a gutter channel of the gutter system. When the gutter system has a plurality of gutter channels, the UAV may be programmed to deliver the cleaning unit to the gutter channels sequentially.

The cleaning unit can clean the gutter system automatically or under the control of a user. The cleaning unit may have its own power or receive power from the UAV. The cleaning unit may have its own controller and communication unit. The cleaning unit may be detachably or permanently coupled to the UAV or other suitable parts of a drone. A telescoping structure may be utilized to release the cleaning unit into a gutter channel.

The UAV cleaning system as described in the present application can be easily set up and operated by a user. It can clean the gutter in a safe, fast, efficient, and economic manner. Ladders and ropes are not required by the present cleaning system.

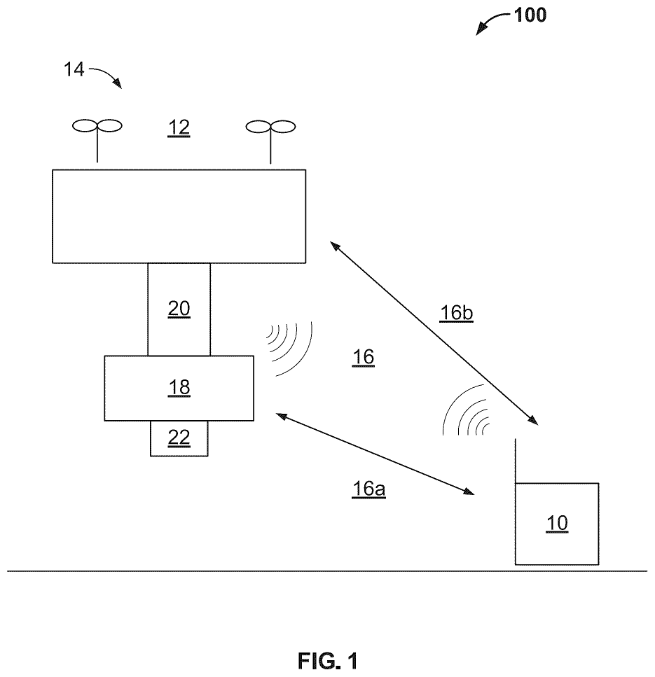

FIG. 1 illustrates a schematic configuration of a cleaning system 100, according to an embodiment of the present application. The cleaning system 100 has a payload 18, which is capable of cleaning a gutter channel of a gutter system. As shown in FIG. 1, the cleaning system 100 includes a remote controlling device 10 and a flying device 12. The remote controlling device 10 and the flying device 12 are capable of communicating with each other via a wireless link 16, such as Bluetooth, Wifi, 5G, LTE, or any other suitable communication links. In an embodiment, the wireless link 16 may include a first link 16a for communication between the remote controlling device 10 and the payload 18 and a second link 16b for communication between the remote controlling device 10 and the flying device 12.

The remote controlling device 10 may include one or more of a wireless controller, a smartphone, a tablet computer, a laptop computer, a ground station, a wearable device (e.g., a watch, a bracelet, or the like), and the like. The remote controlling device 10 is configured to control the flying device 12 and a payload 18 coupled to the flying device 12. In an embodiment, the remote controlling device 10 may communicate with the payload 18 directly or may communicate with the payload 18 via the flying device 12.

In some embodiments, the remote controlling device 10 may include an interactive device configured to interact with the user. The interactive device may include one or more of a touch display screen, a keyboard, keys, a joystick, and a pulsator. The interactive device may include an App and a user interface, and the App can be displayed on the user interface. The App can display an electronic map, and the user can perform a click operation on the electronic map displayed on the App on the user interface of the controlling device 10. A point on the electronic map can be confirmed by performing the click operation once. After receiving at least two points confirmed by the click operation, the controlling device 10 can connect the at least two points to form a connection between the at least two points. A flying trajectory formed by connecting the at least two points can be formed, such that the flying device 12 can be controlled to fly according to the flying trajectory, and the payload 18 can perform the cleaning function along the shooting trajectory. It can be appreciated that the click operation on the user interface is merely an example method for confirming the shooting trajectory, and the manner of confirming the shooting trajectory is not limited herein.

The flying device 12 is capable of lifting a payload 18 off the ground and position the payload 18 into a gutter channel. The flying device 12 may include a rotary-wing device or a fixed-wing device. A rotary-wing device may include a tri-rotor UAV, a quad-rotor UAV (quadcopter), a six-rotor UAV, or an eight-rotor UAV. A fixed-wing device may include a fixed-wing UAV. The flying device 12 includes a rotor system 14 configured to provide a lifting force for the flying device 12. The rotor system 14 may include a plurality of rotors, such as three rotors, four rotors, six rotors, or even a greater number of rotors. The flying device 12 further includes an attachment structure 20 for coupling the payload 18 to the flying device 12.

In an embodiment, the payload 18 may include a cleaning unit configured to perform a cleaning function. The cleaning unit may include an air blower, a rotary head, a burner, a liquid sprayer, or any other suitable cleaning device. In an embodiment, the payload 18 may include a vision system 22 configured to provide a machine vision to the cleaning system 100. The vision system 22 may include, but is not limited to, a multispectral imager, a hyperspectral imager, a visible light camera, an infrared camera, an ultrasound sensor, a laser range finder, and the like.

The attachment structure 20 may include a multi-axis transmission and stabilization system, such as a gimbal structure. The attachment structure 20 may also include any other suitable coupling mechanisms, such as bolts, screws, clips, buckles, latches, and magnetic mechanisms.

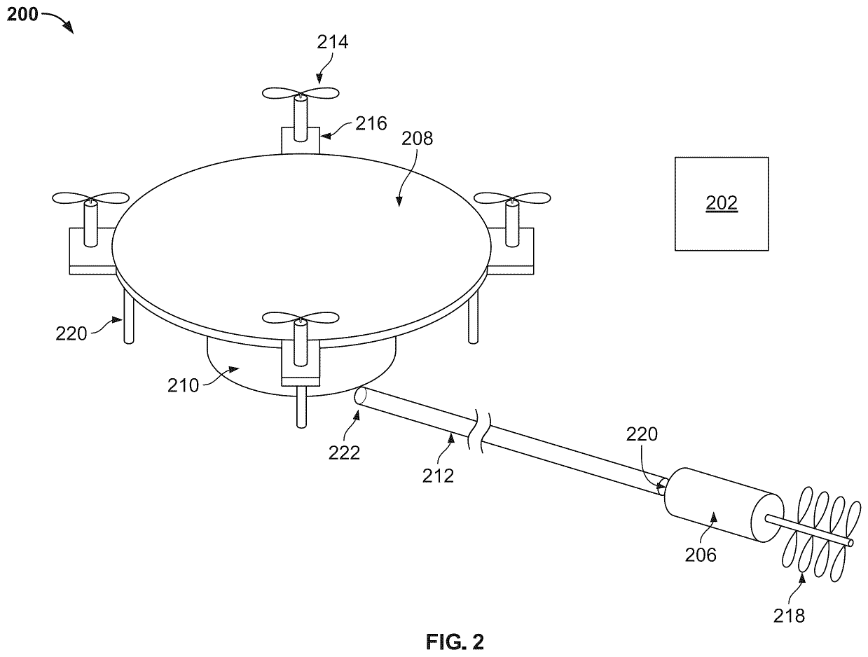

FIG. 2 illustrates a perspective view of a cleaning system 200, according to an embodiment of the present application. The cleaning system 200 includes a flying device 208 and a cleaning unit 206. A remote controller 202 is disposed outside of the flying device 208 and the cleaning unit. The remote controller 202 is configured to control the flying device 208 and the cleaning unit 206. The cleaning system 200 further includes an attachment structure 212 that couples with both the flying device 208 and the cleaning unit 206. In an embodiment, the attachment structure 212 may be a telescoping structure, such as a telescoping rod, which may be rigid or flexible. In another embodiment, the attachment structure 212 may include a rod, a tube, or a cable.

The attachment structure 212 includes a coupling mechanism 222 disposed at an end abutting the cleaning unit 206. In an embodiment, the coupling mechanism 222 is configured to detachably couple the cleaning unit 206 to the telescoping structure 212. For example, the coupling mechanism 222 may include an electromagnetic mechanism whose magnetic field can be controlled by electricity. At another end of the attachment structure 212, a coupling mechanism 222 is used for coupling the attachment structure 212 to the flying device 208. The coupling mechanism 222 is coupled to a gimbal structure 210 of the flying device 208. The gimbal structure is configured to rotate the telescoping structure in a plurality of directions, such as an azimuth director and a pitch direction. In an embodiment, the coupling mechanism 222 is coupled directly to a fuselage of the flying device 208.

The flying device 208 includes a plurality of rotors 214 driven by an actuator 216. The plurality of rotors 214 may include three, four, or a greater number of rotors. The actuator 216 may include a motor or a combustion engine. As shown in FIG. 2, the coupling mechanism 222, the attachment structure 212, and the cleaning unit 206 are disposed at a bottom side of the flying device 208, while the plurality of rotors are disposed at an upper side of the flying device 208.

In an embodiment, a plurality of supporting frames 220 supports the flying device 208 for taking off. The supporting frames 220 are configured to raise the flying device 208 to provide adequate space to dispose the attachment structure 212 and the cleaning unit 206 under the flying device 208. In an embodiment, the supporting frames 220 are not attached to the flying device 208. As a result, when the flying device 208 is lifting the cleaning unit 206 above the ground, the supporting frame 220 is left on the ground. In another embodiment, the supporting frames 220 are attached to the flying device 208 and lifted above the ground together with the cleaning unit 206.

The cleaning unit 206 includes a cleaning head 218. The cleaning head 218 is configured to remove any debris, dusts, or other clogging material from a gutter channel. In an embodiment, the cleaning head 218 may include an air blower or a rotary mechanical part, such as a rotary blade or a rotary brush.

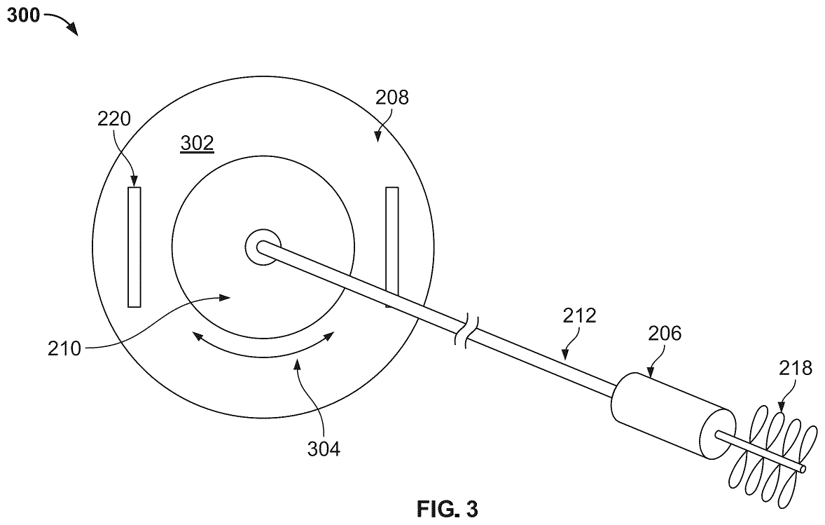

FIG. 3 illustrates a bottom view of the cleaning system 200, according to an embodiment of the present application. The supporting frame 220 is coupled to the bottom side of a fuselage 302 of the flying device 208. The supporting frame 220 is configured to raise the fuselage to a predetermined height such that the gimbal structure 210, the attachment structure 212, and the cleaning unit 206 can be stowed under the fuselage 302 before the flying device 208 takes off. The supporting frame 220 may be permanently attached or detachably attached to the fuselage 302. The supporting frame 220 may be in any suitable shape, such as a rectangular shape, a cylindrical shape, a frustum shape, or any other shapes. In an embodiment, the supporting frame 220 is left on the ground after the flying device 208 lifts the cleaning unit 206 above the ground. In this manner, the supporting frame 220 does not interfere with the operation of the attachment structure 212. As shown in FIG. 3, the gimbal structure 210 is capable of rotating the telescoping structure 212 along an azimuth direction 304 to orient the cleaning unit 206.

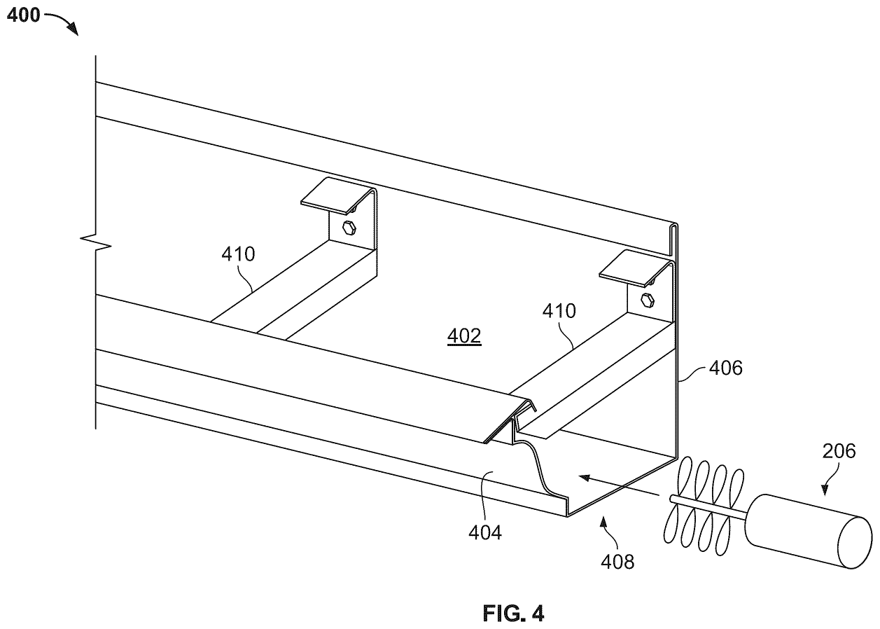

FIG. 4 illustrates a cleaning unit 206 in a gutter system 400 for cleaning, according to an embodiment of the present application. The gutter system 400 includes a gutter channel 402 having a cross-sectional profile formed by a front wall 404, a back wall 406, and a bottom section 408. At the upper part of the gutter channel 402, a plurality of hangers 410 are used to connect the front wall 404 and the back wall 406. The plurality of hangers 410 also secure the gutter system 400 to another structure, such as a roof. In an embodiment, the cleaning unit 206 is released into the gutter system 400 by decoupling from the attachment structure 212. The cleaning unit 206 is capable of moving along the bottom section 408 of the gutter channel and beneath the plurality of hangers 410 to clean the gutter system 400 by blasting and blowing off the dirt out of the gutter system 400.

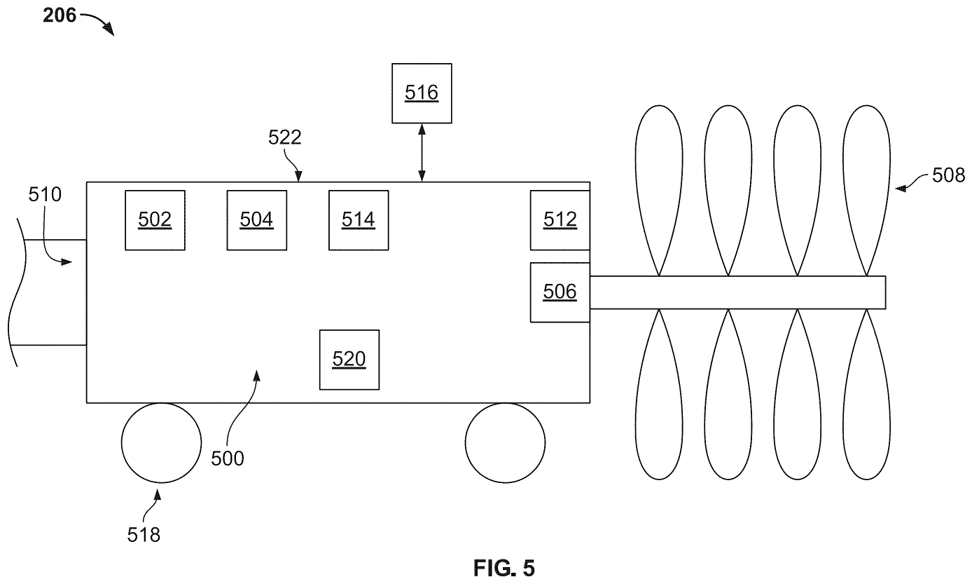

FIG. 5 illustrates a schematic configuration of the cleaning unit 206, according to an embodiment of the present application. The cleaning unit 206 includes a body 500 coupled with a cleaning head 508. The body 500 is configured to house various functional components for communication, power, control, perception, and coupling with other structures. The cleaning head 508 is configured to remove the dirt out of the gutter channels.

In an embodiment, the body 500 contains a power source 502, a controller 504, a wireless communication unit 514, an actuator 506, and a vision system 512. The power source 502 may include a battery, which is configured to provide electricity to other components of the cleaning unit 206. The controller 504 is configured to control the cleaning unit 206. The wireless communication unit 514 is configured to communicate with a remote controller 516. The communication may include a direct peer to peer communication or a communication via Internet. In an embodiment the controller 504 receives instructions from the remote controller 516 via the wireless communication unit 514. The actuator 506, such as a motor, is configured to drive the cleaning head 508. The actuator 506 receives power from the power source 502 and is controlled by the controller 504. The vision system 512, such as a camera, may be disposed at the same end as the cleaning head 508 and capture images of the gutter channel. In an embodiment, the images captured by the vision system 512 is transmitted to the remote controller 516 via the wireless communication unit 514.

The cleaning unit 206 may also include a coupling component 510 and a plurality of wheels. In an embodiment, the coupling component 510 is disposed at an opposite end to that of the cleaning head 508. The coupling component 510 may also be disposed at other locations of the cleaning body 500, such as an upper side 522. The coupling component 510 is configured to couple with another coupling component disposed the attachment structure 212. The coupling component 510 may couple with or decouple from the attachment structure 212. In an embodiment, the coupling component 510 includes an electromagnet, whose magnetic field may be activated by the battery 502. In another embodiment, the coupling component 510 may include a permanent magnet. The plurality of wheels 518 is configured to provide mobility to the cleaning body 500 such that the cleaning body 500 can move the cleaning head 508 along the gutter channel. The plurality of wheels 518 may be driven by a motor 520. In an embodiment, the plurality of wheels may be replaced or combined with other mobility mechanisms, such as tracked treads.

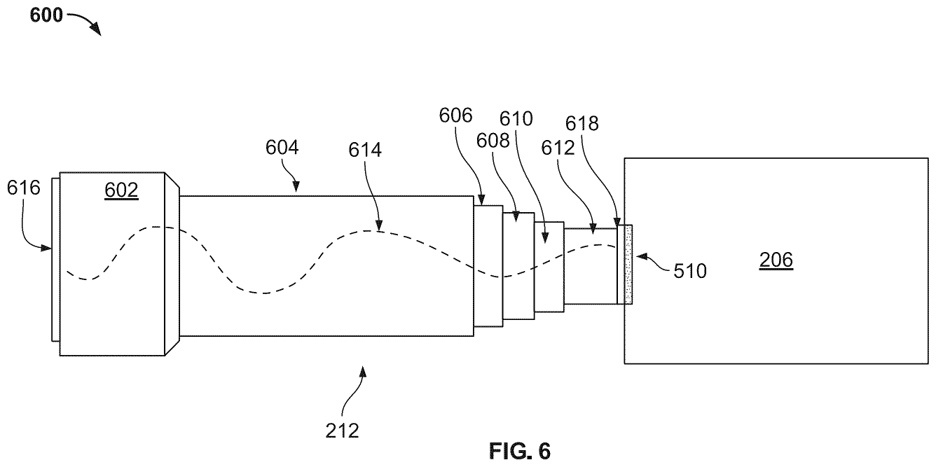

FIG. 6 illustrates a schematic configuration of a telescoping structure 600, according to an embodiment of the present application. In an embodiment, the telescoping structure 600 includes a base 602 and a plurality of telescoping segments 604-612 nesting within each other. The base 602 is configured to couple with the flying device 208. The plurality of segments 604-612 includes a first segment 604 coupled with the base 602. Other segments 606-612 are nested within adjacent segments. In an embodiment, the plurality of segments are configured to telescope by the weight of the cleaning unit 206. In an embodiment, the plurality of segments are configured to hold the weight of the cleaning unit 206 without telescoping, and can be manually extended by a user.

The telescoping structure 600 may include a coupling component 616 disposed at one end and another coupling mechanism disposed at another end. The coupling component 616 is disposed in or on the base 602 and is configured to couple to the gimbal structure 210 or the fuselage 302 of the flying device 208. The coupling component 618 is configured to couple with the cleaning unit 206. In an embodiment, the coupling component 618 and the coupling component 510 may form a detachable coupling mechanism. For example, one or both of the coupling components 618 and 510 may include an electromagnet. The telescoping structure 600 may also include an electric wire 614 disposed inside the plurality of the segments. The electric wire 614 is configured to provide electricity to the coupling component 618. In an embodiment, the electric wire may be connected to a power source of the flying device 208.

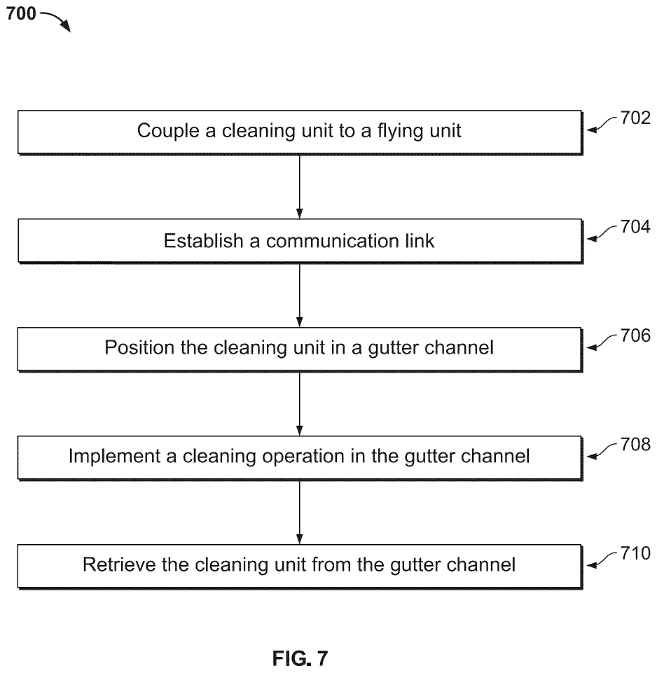

FIG. 7 illustrates a method 700 of cleaning a gutter system, according to an embodiment of the present application. At operation 702, a user sets up the cleaning system 200, which includes the cleaning unit 206 to a flying device 208. The cleaning unit 206 may be provided as a retrofit kit to the flying device 208. The retrofit fit may also include the telescoping structure 600. The user utilizes the telescoping structure 600 to couple the cleaning unit 206 to the flying device 208. In an embodiment, the flying device 208 includes a gimbal structure 210, and the telescoping unit 600 is coupled to the gimbal structure 210.

At operation 704, both the flying device 208 and the cleaning unit 206 are powered up. A communication link is established between the remote controller 202 and the flying device 208. The same communication link may also be used for communication between the remote controller 202 and the cleaning unit 206. In an embodiment, a different communication link is established between the remote controller 202 and the cleaning unit 206.

At operation 706, the user controls the flying device 208 to position the cleaning unit 206 to a gutter channel. The telescoping structure 600 extends its length under the weight of the cleaning unit 206. The gimbal structure 210 can orient the cleaning unit 206 in different directions after the flying device 208 hovers above the gutter channel. When the cleaning unit 206 is aligned with the gutter channel, the user may instruct the cleaning unit 206 or the flying device 208 to release the cleaning unit 206 into the gutter channel. Cameras of either the flying device 208 or the cleaning unit 206 may provide the vision about the location and orientation of the cleaning unit 206.

At operation 708, the flying device 208 returns to a landing area. The cleaning unit 206 has a vision system configured to provide images or videos about the condition of the gutter channel. The user instructs the cleaning unit 206 to start a cleaning operation inside and along the gutter channel. The cleaning unit 206 may utilize an air blower or a rotary head to blast the dirt out of the gutter channel. The vision system continues providing images showing conditions of the gutter channel.

At operation 710, the cleaning unit 206 completes the cleaning operation of a channel segment. The flying device 208 moves to the location of the cleaning unit 206 and utilizes the telescoping structure 600 to retrieve the cleaning unit 206. In an embodiment, a magnetic coupling mechanism is utilized for the coupling mechanism. The flying device 208 may take the cleaning unit 206 to another channel segment or take the cleaning unit 206 to a landing area.

In an embodiment, during operations 706 and 708, the cleaning unit may be operated in a manual mode, a program-assistance mode, or an autonomous mode. The user may select a mode via a control interface for operating the cleaning unit.

In a manual mode, the user manually controls the cleaning unit, such as positioning the cleaning unit, directing the flying path, directing the cleaning path, selecting the cleaning processes, and determining other parameters and actions of the cleaning unit. For example, the user may utilize a control stick or a control interface to fly the cleaning unit to certain height and then toward an intended direction. The user may instruct the cleaning unit to implement a cleaning process according to a visual image taken by the cleaning unit.

In a program-assistance mode, the user may identify a segment of a gutter for cleaning by using the remote controller, such as by setting a starting point and an end point along a gutter. The user may also manually fly the cleaning unit to a height above a gutter to be cleaned. Then, the cleaning unit cleans the gutter automatically according to pre-set navigation and cleaning algorithms. After a segment of the gutter is cleaned, the user may move the cleaning unit to another location, re-program the cleaning unit, and then instruct the cleaning unit to clean the gutter.

In an autonomous mode, the user may simply identify the building or the approximate contour of a gutter system to be cleaned. Then, the cleaning unit may clean the entire gutter system of the building or along the contour automatically. The cleaning unit may utilize an artificial intelligence model to identify the gutters of a building or locate the gutters more precisely along the contour marked by the user.

The foregoing Detailed Description is to be understood as being in every respect illustrative and exemplary, but not restrictive, and the scope of the inventive concept disclosed herein is not to be determined from the Detailed Description, but rather from the claims as interpreted according to the full breadth permitted by the patent laws. It is to be understood that the embodiments shown and described herein are only illustrative of the principles of the inventive concept and that various modifications may be implemented by those skilled in the art without departing from the scope and spirit of the inventive concept. Those skilled in the art could implement various other feature combinations without departing from the scope and spirit of the inventive concept.

What is claimed is:

1. A cleaning system for cleaning a channel raised above a ground, comprising:
a cleaning unit comprising a cleaning head coupled to a cleaning body;
a flying device coupled with the cleaning unit and configured to lift the cleaning unit above the ground and position the cleaning unit above the channel; and
a remote controller configured to control the flying device and the cleaning unit,
wherein the cleaning head includes an air blower or a rotary head.

2. The cleaning system of claim 1, further comprising a telescoping structure coupled with both the flying device and the cleaning unit.

3. The cleaning system of claim 2, further comprising an electrical wire disposed within the telescoping structure.

4. The cleaning system of claim 3, further comprising a first coupling mechanism that couples the telescoping structure with the cleaning unit with an electromagnet.

5. The cleaning system of claim 3, further comprising a second coupling mechanism that couples the telescoping structure with the flying device.

6. The cleaning system of claim 1, wherein the cleaning unit is configured to be detached from the flying device and released into the channel.

7. The cleaning system of claim 6, wherein the rotary head includes a blade, a brush, an air blower, or a liquid sprayer.

8. The cleaning system of claim 7, wherein the cleaning unit includes a vision system comprising a camera.

9. The cleaning system of claim 8, wherein the cleaning unit includes a battery configured to provide electricity to the rotary head and the vision system.

10. The cleaning system of claim 8, wherein the cleaning unit includes a plurality of wheels.

11. The cleaning system of claim 8, wherein the cleaning unit comprises a wireless transmitter configured to communicate with the remote controller.

12. The cleaning system of claim 1, further comprises:
a gimbal structure coupled with a telescoping structure, wherein the gimbal structure is configured to orient the telescoping structure to different directions.

13. The cleaning system of claim 12, further comprising a support frame configured to support the flying device, wherein the support frame is configured to be left on the ground when the flying device lifts the cleaning unit.

14. The cleaning system of claim 13, wherein the telescoping structure is configured to extend under a weight of the cleaning unit.

15. The cleaning system of claim 1, wherein the flying device includes at least four rotors, and the rotors are driven by a motor or a combustion engine.

16. A method for cleaning an above-ground gutter system comprising:
coupling a cleaning unit to a flying device;
establishing a communication link between a remote controller and the cleaning unit;
controlling the flying device to position the cleaning unit in a gutter channel; and
controlling the cleaning unit to implement a cleaning operation in the gutter channel, wherein the cleaning operation includes rotating a mechanical head or blowing air in the gutter channel.

17. The method of claim 16, further comprising:
rotating, by a telescoping rod, the cleaning unit in different directions; and
releasing the cleaning unit from the telescoping rod into the gutter channel.

18. The method of claim 17, further comprising:
controlling electric power to an electromagnet of the cleaning unit.

19. The method of claim 18, further comprising:
providing, by a camera installed on the cleaning unit, an image showing conditions of the gutter channel.

20. The method of claim 18, further comprising:
retrieving the cleaning unit via the telescoping rod coupled to the flying device.
